(19) United States
(12) Patent Application Publication
(10) Pub. No.: US 2005/0063892 A1
(43) Pub. Date: Mar. 24, 2005

(54) Thermally modified carbon blacks for various type applications and a process for producing same

(76) Inventors: Deepak Tandon, Kennesaw, GA (US); Jore Armando Ayala, Kennesaw, GA (US); Rodney Lynn Taylor, Acworth, GA (US); Mark S. Zak, Norwalk, CT (US); Igor V. Barsukov, Glenview, IL (US); Joseph E. Doninger, Lake Forest, IL (US); Peter Booth, Geneva, IL (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002, US

(21) Appl. No.: 10/666,048

(22) Filed: Sep. 18, 2003

(51) Int. Cl. H01M 4/62; C09C 1/48

(52) U.S. Cl. 423/449.1; 429/232

(57) ABSTRACT

An electro thermal fluidized bed furnace is adapted to be used in a process for continuously heat treating of fine particulate matter, such as carbon black material, by continuously introducing a non-reactive fluidizing gas through the nozzles of the furnace at a pre-determined rate, continuously introducing untreated carbon black material through the feed pipe of the furnace at a predetermined rate so that it forms a fluidized bed, energizing the electrode so as to heat the fluidized bed, and continuously collecting the treated carbon black from the discharge pipe. The carbon black collected from the discharge pipe exhibits properties of having the PAHs and sulfur removed, the carbon black has been graphitized, the moisture pick-up by the carbon black has been eliminated and the carbon black is more oxidation resistant, Furthermore, the resultant furnace carbon backs have a particle size of 7-100 nm and an oil absorption number of 50-300 ml/100 g., while the thermal blacks have a particle size of 200-500 nm and an oil absorption number of less than 50 ml/100 g. All of these properties result in thermally modified carbon blacks having such properties and of such purity so as to provide improved performance properties in food contact type applications, moisture cured polymer systems, zinc-carbon dry cell battery applications, and semi-conductive wire and cable applications.

### CROSS-REFERENCE TO RELATED APPLICATIONS

Not applicable

### REFERENCE TO A “MICROFICHE APPENDIX”

Not applicable

### BACKGROUND OF THE INVENTION

1. Field of the Invention

The present invention relates to heat-treated carbon blacks. More particularly, the present invention relates to thermally modified carbon blacks which possess improved performance properties in food contact type applications, moisture cured polymer systems, zinc-carbon “dry cell” batteries, alkaline Zinc-Manganese Dioxide batteries, other electrochemical power sources and electronic applications and for semi-conductive wire and cable applications, and additional applications; the carbon blacks produced by a proprietary continuous heat treatment process.

2. General Background of the Invention

Historically, carbon black materials have had a myriad of applications in all phases of the economy, and a wide range of products on the market include a carbon black material as part of their composition. However, it has been found that under certain settings and uses, it is much more favorable to utilize a carbon black which would have certain properties including a very high purity of carbon black materials. In the past, it has been difficult to produce such high purity carbon blacks for commercial use in sufficient quantities or with a production time sufficiently short to permit economic viability. At present, there is a need in certain industries for having carbon blacks which possess improved performance properties; these applications include, but are not limited to, food contact type applications, moisture cured polymer systems, zinc-carbon “dry cell” batteries, alkaline Zinc-Manganese Dioxide batteries, other electrochemical power sources and electronic applications, and for semi-conductive wire and cable applications. The high purity carbon blacks which could be utilized in these applications could be carbon blacks produced by a proprietary continuous heat treatment process, of the type discussed herein.

Food Contact-Type Applications

Food and Drug Administration (FDA) regulations, namely 21 CFR 178.3297 allows the use of high-purity furnace blacks (<500 ppb of 22 polycyclic aromatic hydrocarbon (PAH) compounds with <5 ppb of benzo alpha pyrene) as colorants for polymers (up to 2.5 wt. % loading) used in producing, manufacturing, packing, processing, preparing, treating, packaging, transporting or holding food under all temperatures. Typical furnace blacks have PAH levels that are higher than allowed under the FDA regulations. There are a very limited number of furnace carbon black grades available that meet the FDA limits. However, these grades offer only limited morphology. Channel blacks, which are also used in such applications, are exempt from the FDA regulations but are no longer produced in the western hemisphere or in western Europe.

It would be beneficial to produce thermally modified carbon blacks which have the necessary properties to meet all FDA guidelines in food-contact applications and with a wide range of morphologies.

As used herein carbon black morphology encompasses primary particle size and size distribution, and aggregate size and aggregate size distribution as measured by ASTM-D3849.

Semi-Conductor Cable and Wire Applications

Carbon blacks are used in insulated electric power cable semi-conducting shields. The volume resistivity of these semiconducting materials is typically in the range of 10⁻¹ to 10⁸ ohm-cm. These materials typically contain a polyolefin, a conductive carbon black, an antioxidant and other additives. The main objective of these shields is to ensure long life of the primary insulation via prevention of accumulation of static charge. Longer cable life is desirable and is achieved through interfacial smoothness of the conductor shield. Surface smoothness can be achieved by using larger particle size (low surface area) carbon blacks. However, the larger particle carbon blacks have higher resistivity. Acetylene carbon black is commonly used to provide superior interfacial smoothness in semiconductor compounds. However, this type of black is difficult to produce and process, and available in only a very limited range of morphologies compared to furnace carbon blacks.

It would be beneficial to produce thermally modified furnace carbon blacks which provide compounds with interfacial smoothness at least equivalent to acetylene carbon black; which would be easier to process and provide better conductivity and melt flow properties; and which can be obtained with varied morphologies as opposed to acetylene black and which have lower moisture adsorption characteristics, which is also a highly desirable property in semiconductive compounds.

Electrochemical Power Sources.

Under the term “Electrochemical power sources” we understand devices that can produce electric current as a result of chemical or electrochemical reaction. Carbonaceous materials are widely used in the stationary and portable power sources. There are about 50 commercially viable electrochemical power sources on the worldwide market. Most of them use carbons for one or more reasons in their design.

The application for carbonaceous materials can be split into several major groups, which are described below, and which can be referenced to the published literature:
[1] I. Barsukov. Applications for Battery Carbons./Battery Power Products and Technology, v. 4, 9, P.30, 2000.
[2] I.V. Barsukov, J. E. Doninger, P. L. Zaleski. Novel Classification and an Application Overview of Graphitic Products used in Power Sources./Book of Abstracts of the 54th Annual Meeting of the International Society of Electrochemistry, Sao Pedro, Brazil, Abstract #445, 8-9/2003.

Carbon additives, which enhance electronic conductivity of battery active materials: Used in nearly all alkaline primary and rechargeable, lead-acid and Lithium primary battery systems, as well as in the positive electrodes of the Lithium-Ion and Lithium-Polymer batteries.

Graphitic carbon as electrode active material: Used in the Lithium-Ion, Lithium-Ion Polymer, some metal-free and semi-metal batteries.

Catalysts of chemical and electrochemical reactions in batteries and fuel cells: An example of such an application is the gas diffusion electrode of the zinc-air or “hearing aid” battery system as well as a gas diffusion layer of Fuel cells.

Carbon as battery assembly components and “processing aid” additives: Applications include separator plates of the Fuel Cells, carbon rods of the carbon/zinc (“heavy duty”) cells, carbon-carbon composite batteries, supercapacitors, etc.

Application of carbonaceous materials as an ingredient of the coatings used in power sources: Some examples of the carbon coating applications are listed below: the double layer electronic capacitors, electrochemical ultracapacitors “supercapacitors”, Zinc-carbon batteries; current collector substrate coating of: Lithium-Ion polymer cathodes and anodes, Lithium-Ion batteries with liquid electrolyte (foil coating for positive and negative electrodes), Zinc-air primary and rechargeable batteries, can coating of the Zinc Alkaline Manganese Dioxide primary and rechargeable batteries.

The invention, which is described in the present application, relates to all of the above-mentioned applications and includes all commercially viable and development-stage portable and stationary types of power sources.

A few substantiating examples of the carbonaceous material's properties needed in power sources can be seen below.

Zinc-Carbon “dry cell” Battery Applications

Acetylene carbon black is typically used in dry cell (Zinc-carbon) batteries to impart conductivity to the cathode (manganese dioxide) and also to hold (absorb) the electrolyte. This ability to hold more electrolyte in the cathode mix makes acetylene black an attractive material. However, care must be exercised during the mixing process so as to prevent intense shearing of carbon black aggregates (structural breakdown), as this will reduce its ability to hold the electrolyte. Acetylene black has a high but weak aggregate structure. (See D. Linden, Handbook of Batteries and Fuel Cells, 3^{rd} ed., McGraw-Hill Book Co., Inc. New York, N.Y. 1995). The desirable properties of acetylene black are low sulfur, low moisture pickup and high electrolyte absorption capacity.

It would be beneficial, therefore, to produce thermally modified carbon blacks which possess all the desired properties of acetylene black, plus a stronger aggregate structure and superior resistance to thermal oxidation.

Alkaline Battery Systems.

Primary and secondary alkaline batteries of the electrochemical system Zn\KOH\MnO₂ represent the largest segment of this category of power sources. In those, carbonaceous powdered materials are used for the purpose of conductivity enhancement of the MnO₂, (electrolytic manganese dioxide (EMD) or chemical manganese dioxide (CMD) cathodes. Also, the carbon-containing conductive suspensions often referred to as “can coating” are used in these batteries as a processing aid and a conductivity bridge at the interface: EMD cathode-positive current collector.

Conventional carbon (and/or acetylene) blacks have been phased out from most of the zinc-alkaline manganese dioxide batteries in mid 1980s, at least from the conductivity enhancement application in this battery system. However, some battery companies sometimes still add small percentages of carbon (acetylene) black (0.01-8 wt % to the MnO₂ based electrodes) in order to enhance high discharge current density performance of certain power sources. However, the limitation for application of carbonaceous materials is high probability for thermodynamically unstable reaction to take place between the carbon (acetylene black) and MnO₂. Having graphitic nature of carbon black structure, reduced amounts of the surface groups (amounts of oxygen reach chemistries on carbon's surface) and possibly coarser particle size in carbon black, as well as controlled “spring back” characteristic of the powder, yet with higher to comparable conductivity of MnO2 matrixes, which could be offered by mixing of MnO2 with other carbonaceous materials, such as for instance, graphite, could enable application of carbon black in this electrochemical system either as the only carbonaceous material or as part of the engineered blend or composite. Heat-treating of the carbon black in accordance with the process described below can make it suitable for the application in question.

Moisture Cured Polymer Systems Applications

One of the most critical requirements for the carbon blacks in a sealant application is a very low moisture pickup. The sealant manufacturers have to dry the carbon blacks and then have to keep them under dry nitrogen to prevent any moisture pickup. This increases the number of process steps and thus adds significant cost to the process. Therefore, it would be beneficial to produce thermally modified carbon blacks which have virtually zero moisture pickup and thus eliminate the need for carbon black drying and storage under a moisture free environment.

Other Applications for Heat Treated Graphitic Carbon Black.

There are a number of applications, where heat treated carbon black that is subject of this invention, could be used alone or as part of the blend (or engineered composite)with other materials, as a viable alternative to conventional carbon blacks. The list includes, but is not limited to the Ingredients of the electronic resistance dependent applications (examples: Ingredient of microphones, resistors, strain-, temperature- and current-sensitive resistors), oil drilling additive (example: application for stop loss circulation well and oil drilling market to be used as is or together with other stop loss additives, including but not limited to graphite, other forms of carbon black, glass beads, etc.).

The Current Furnace Treatment Process

One important aspect of producing carbon blacks of sufficient purity to meet the applications as recited above, and many other potential applications, concerns the method in which the carbon blacks are thermally modified under the heat treatment process. While high purity carbon blacks have been produced previously by batch graphitization methods, such methods require days or weeks to complete the process, and the resulting pure carbon blacks have not been available in commercial quantities or at reasonable prices. Heat-treated carbon blacks can also be used as the ingredients for thermal conductivity improvement (example—cure bladder compounds, heat-transfer fluid, etc.)

It is known to use an electro thermal fluidized bed (EFB) furnace for the high temperature purification of carbonaceous materials and for high temperature chemical synthesis as disclosed in U.S. Pat. Nos. 4,160,813 and 4,547,430, respectively.

These processes use a fluidized bed furnace, as illustrated in U.S. Pat. No. 4,543,240, in which the cross-section of the fluidized bed portion of the EFB furnace is substantially constant along its height and the fluidizing gas is introduced into the furnace through a multiplicity of generally vertically oriented gas nozzles extending through a plate distributor at the bottom of the furnace. This type of EFB furnace is commonly referred to as a “bubble” EFB furnace.

The methods of purification and thermal treatment using a bubble EFB furnace worked for particles as small as 106 μm (140 mesh). However, bubble EFB furnaces have not performed well with respect to smaller than 75 μm (200 mesh)materials. Additionally, such furnaces are not effective for use with irregularly shaped particles such as flakes, needles, and other shapes, or with particles having a wide range of particle-size distribution (“polydispersed”), particularly where the material comprises a high content (greater than 30%) of fine particles with sizes less than 150 μm (100 mesh).

The use of bubble EFB furnaces to treat and/or synthesize polydispersed materials has resulted in the entrainment of particles smaller than 106 μm (140 mesh). That is, the particles are circulated by the fluidizing gas outside of the active area of the EFB furnace. This results in a low recovery rate of treated product as a percent of raw material. This has proven to be especially the case in bubble EFB furnaces where the raw materials are introduced at the top of the fluidized bed and the treated particles are discharged from the bottom fo the furnace.

With respect to fine particles, particularly those smaller than 40 μm (325 mesh), and those of irregular shape, it has proven very difficult, or at times impossible, to uniformly fluidize such particles in a bubble EFB furnace, because of channel passages of fluidizing gas. This is believed to be due to the high cohesion forces (in grams/inches²) between the small particles that result from the relatively large surface area for fine particles and also because of stagnation zones for the fluidizing gas that form in the bottom portion of the fluidized bed.

Those shortcomings are the result of the particular hydrodynamics of a bubble EFB furnace. In particular, the plate gas distributor and its plurality of vertically oriented gas nozzles create a number of local circulating zones that have an upward flow of particle/gas mixture and a downward flow fo particles, with each zone being formed around a single nozzle or group of nozzles on the distribution plate.

### BRIEF SUMMARY OF THE INVENTION

In the process to produce the high purity carbon blacks of the present invention there is provided a novel electro thermal fluidized bed furnace in which the furnace body has upper and lower cylindrical portions, with the upper cylindrical portion having a diameter larger than that of the lower cylindrical portion. A conical portion is disposed below the lower cylindrical portion so that the conical portion and the lower cylindrical portion define a fluidizing zone while the upper cylindrical portion defines an overbed zone. The furnace includes at least one electrode extending through the upper and lower cylindrical portions and a treated material discharge pipe at the lower end of the conical portion. A feed pipe is provided for introducing raw material into the lower cylindrical portion, and at least one gas flue is provided at the top of the furnace body for discharging fluidizing gas. A plurality of nozzles is disposed in the conical section for introducing fluidizing gas into the furnace, with the nozzles being arranged in a generally horizontal plane and orientated so that the streams of the fluidizing gas introduced there through cross and form an upward flow in the central portion furnace body.

Such an electro thermal fluidized bed furnace is adapted to be used in a novel process for continuously heat treating of fine particulate matter, such as carbon black material, by continuously introducing a non-reactive fluidizing gas through the nozzles of the furnace at the pre-determined rate, continuously introducing untreated carbon black material through the feed pipe of the furnace at a predetermined rate so that it forms a fluidized bed, energizing the electrode so as to heat the fluidized bed, and continuously collecting the treated carbon black from the discharge pipe. The treatment process used for thermally modifying the carbon blacks of the present invention is disclosed in its entirety in U.S. patent application, entitled a “Method and Apparatus For Heat Treatment of Fine Particulates In An Electrothermal Fluized Bed Furnace,” bearing Ser. No. ______, filed ______, assigned to Superior Graphite Co. The entire contents of this patent application are incorporated herein by reference thereto.

The carbon black collected from the discharge pipe exhibits properties of having the PAHs and sulfur substantially removed, the carbon black has been substantially graphitized, the moisture pick-up by the carbon black has been substantially eliminated and the carbon black exhibits improved oxidation resistance. In addition, the resultant heat treated carbon black has reduced metals and ash content, better flow properties, increased pH, improved thermal conductivity, and is more resilient. Furthermore, the resultant furnace carbon blacks can have a particle size of 7-100 nm and an oil absorption number of 50-300 ml/100 g., while the thermal blacks can have a particle size of 200-500 nm and an oil absorption number of less than 50 ml/100 g.

Furthermore, the aforedescribed continuous process is capable of producing this full morphological range of thermally modified furnace and thermal carbon blacks in commercially useful quantities and with process economics consistent with their use in the intended applications.

All of these properties result in thermally modified carbon blacks having such properties and of such purity so as to provide improved performance properties in food contact type applications, moisture cured polymer systems, zinc-carbon “dry cell” batteries, electrochemical applications such as alkaline batteries, other electrochemical power sources and other electronic applications, and for semi-conductive wire and cable applications; and other applications which may apply but are not necessarily specified herein; the carbon blacks produced by the aforesaid proprietary continuous heat treatment process, or a variation of that process as it may develop.

Accordingly, it is an object of the present invention to provide a method for thermally modifying fine particulate matter, such as carbon black material, in a proprietary electro thermal fluidized bed furnace process, hereinafter sometimes referred to as “the heat treatment process;”It is a further object of the present invention to provide thermally modified carbon blacks produced from the heat treatment process which meet FDA regulations in food contact type applications;

It is a further object of the present invention to provide thermally modified carbon blacks produced from the heat treatment process which improve performance properties of the carbon black for moisture cured polymer systems; e.g., polyurethane foam applications; polyurethane acrylates, cyanoacrylates, epoxies and silicones;

It is a further object of the present invention to provide thermally modified carbon blacks produced from the heat treatment process to be used in zinc-carbon dry cell applications which possess all the desired properties of acetylene black or high structure carbon black, plus a higher conductivity in electrode matrixes, a stronger structure, controlled resilience, electrolyte absorption, and superior resistance to thermal oxidation.

It is a further object of the present invention to provide thermally modified carbon blacks produced from the heat treatment process to be used in alkaline, Lithium-Ion and other electrochemical power sources applications which possesses all the desired properties of acetylene or high structure carbon black, plus a higher conductivity in electrode (active) matrices, stronger structure, controlled resilience, electrolyte absorption and superior resistance to thermal oxidation.

It is a further object of the present invention to provide thermally modified carbon blacks produced from the heat treatment process to be used in electronically conductive applications which possesses all the desired properties of acetylene or high structure carbon black, plus a higher in-matrix conductivity in active matrices, stronger aggregate structure, controlled resilience and superior resistance to thermal oxidation.

It is a further object of the present invention to provide thermally modified carbon blacks produced from the heat treatment process for use in semi-conductor cable applications which provide compounds with interfacial smoothness at least equivalent to acetylene carbon black; which would be easier to process and provide better conductivity and melt flow properties; and which can be obtained with varied morphologies as opposed to acetylene black and which have lower moisture adsorption characteristics, which is a highly desirable property in semiconductive compounds.

It is a further object of the present invention to provide pure carbon blacks produced by the heat treatment process in an electo thermal fluidized bed furnace as to substantially remove PAHs and sulfur, to substantially graphitize the carbon black, to reduce volatile metals content, and to substantially eliminate the moisture pick-up by the carbon black and make the carbon black more oxidation resistant.

It is a further object of the present invention to provide heat treated carbon blacks in the heat treatment process which comprise furnace carbon blacks having a particle size of 7-100 nm and an oil absorption number of 50-300 ml/100 g., and thermal blacks having a particle size of 200-500 nm and an oil absorption number of less than 50 ml/100 g.

It is a further object of the present invention to provide any furnace or thermal carbon black depending on required performance property(s) such as jetness, viscosity/processing, dispersion, impact strength, etc. that is or are critical for the intended application.

It is a further object of the present invention to provide a carbon black exhibiting flexibility in morphology which would allow for carbon black filled polymer master batches to have loadings >40% which has not been achieved thus far for FDA compliant carbon blacks.

### BRIEF DESCRIPTION OF THE DRAWINGS AND TABLES

For a further understanding of the nature, objects, and advantages of the present invention, reference should be made to the following detailed description, read in conjunction with the following drawings, wherein like reference numerals denote like elements and wherein:

FIG. 1 is a vertical cross-sectional view of a fountain EFB furnace according to the present invention.

FIG. 2 is a top view of the fountain EFB furnace of FIG. 1.

FIG. 3 is a cross-sectional view of the EFB furnace taken along line 3-3 of FIG. 1, showing the fluidizing gas distribution nozzles.

FIG. 4 illustrates an alternative arrangement for the fluidizing gas distribution nozzles.

FIG. 5 is a cross section of the LR2016 cell.

FIG. 5A is the galvanic discharge curves for LR2016 batteries.

Table 1 is a Matrix of Carbon Black Properties Imparted as a Result of Thermal Modification and Their Effect on Various Applications.

Table 2 is Moisture Pickup data for as-is and heat-treated carbon blacks.

Table 3 is Metal Impurities, Ash and Sulfur Content of as-is and heat-treated Carbon Blacks.

Table 4 is Colloidal Properties of Heat-Treated Carbon Black and Acetylene Carbon Black.

Table 5 is structure stability of VHS blacks.

Table 6 is Moisture Pickup (MPU) and Melt Flow Properties at 30% loading in 10 MI LDPE.

Table 7 is Volume resistivity versus processability in polyethylene.

Table 8 is Combustion Rate and Activation Energy of 975U before and after heat treatment.

Table 9 is a listing of PAH Compounds regulated by FDA.

Table 10 is PAH Content (ppb) of FDA Compliant Competitive Carbon Black, Heat-treated CDX-975U, heat treated N700 Series Carbon Black and Control N700 Series Carbon Black.

Table 11 is PAH content for N220, N330 Heat-treated N220 and Heat-treated N330 Heat-treated CB Samples.

Table 12 is Summary of Maximum Discharge capacity of as-is and heat-treated carbon black samples at three discharge rates.

### DETAILED DESCRIPTION OF THE PREFERRED EMBODIMENTS

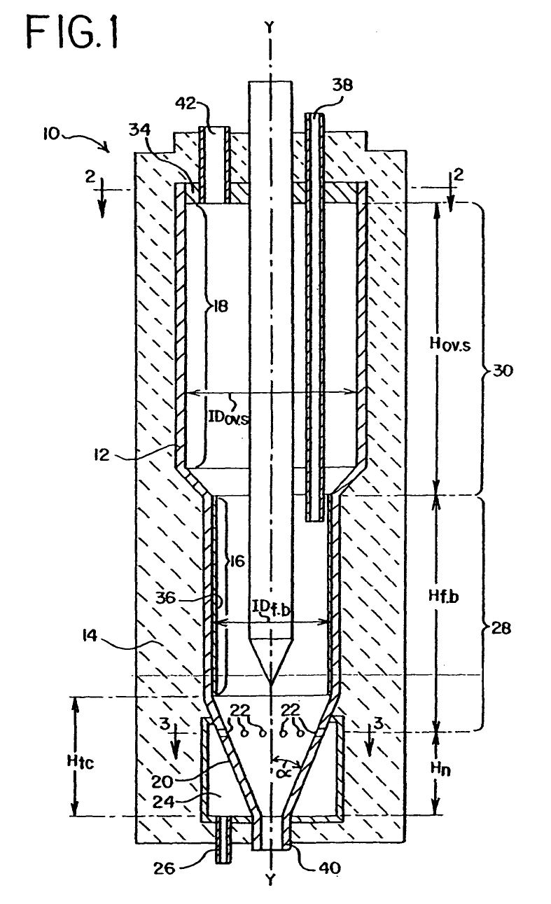

The thermally modified carbon blacks of the present invention possess such properties and are of such purity so as to provide improved performance properties in food contact type applications, moisture cured polymer systems, dry cell batteries, alkaline, zinc air, Lithium-ion, nickel-metal hydrade, nickel cadmium batteries and other electrochemical power sources as well as electrochemical applications, and for semi-conductive wire and cable applications; and other applications which may apply but are not necessarily provided herein. Prior to a discussion of the various applications of the thermally modified carbon blacks of the present invention, reference is first made to FIG. 1 which illustrates an electro thermal fluidized bed furnace and the process through which the aforesaid carbon blacks are thermally modified to provide their unique qualities in their various applications.

Turning to the figures of the drawings, there is seen a fountain-type EFB furnace, generally designated 10, in accordance with the present invention. The principal characteristic of a fountain fluidized bed (also known as a “spout” or “jetting” fluidized bed) is that it has a single strong circulating contour with a central upward flow of particle-gas mixture in the center of the fluidized bed and an outer downward flow of particles along the furnace walls. The high speed central upward flow carries along the solid particles and prevents the formation of find particle clusters, thus preventing channel formation. The vertical velocity gradient provides for a thorough fluidization of all fractions of poly-dispersed grain materials.

With reference to FIG. 1, the furnace includes a furnace body shell 10, typically made of steel and encased with a insulating material 14. The furnace body 12 is typically made of graphite. The furnace body comprises a lower cylindrical portion 16, an upper cylindrical portion 18 disposed above the lower cylindrical portion and having a larger diameter than the central cylindrical portion 16. A conical gas distributor 20 is disposed below the central cylindrical portion 16, with the gas distributor 20 having a plurality of fluidizing gas distribution nozzles 22. The nozzles 22 are in fluid communication with a plenum 24 into which the fluidizing gas is introduced through an inlet 26. The conical gas distributor 20 defines a central angle (alpha) of from 30 to 90, and preferably of from 40 to 60. In such a furnace body 12, the space above the gas distribution nozzles 22 to the top of the lower cylindrical portion 16 generally define the fluidized bed zone 28. The space above the fluidized bed zone, coinciding generally with the upper cylindrical portion 18, is known as the overbed space or free board zone 30. In the furnace of the present invention, the operational height HFB of the fluidized bed area 28 generally coincides with the distance between the nozzles 22 and the upper end of the lower cylindrical portion 18. In order to prevent the formation of a bubble fluidized area in the top portion of the fluidized bed zone 28, HFB is preferably less than or equal to one and one-half to twice the inside diameter IDFB of the lower cylindrical portion 16. The minimal height of the free board or overbed space Hov.s is preferably one and one-half times the height of the fluidized bed Hfb to ensure that any entrained particles are separated from the gas flow and returned to the fluidized bed space of the furnace. Preferably, each of the cylindrical portions 16, 18 and the conical gas distributor 20 has a circular or an elliptical cross-section. Other shaped cross-sections (such as square, rectangular, octagonal, etc.) may exhibit satisfactory hydro-dynamic characteristics. However, such shapes are practically unworkable due to the amount of thermal expansion encountered by the furnace during use.

An elongated electrode 32 extends into the furnace body 12 from the top 34 through the upper and lower cylindrical portions 18, 16, respectively. The electrode 32 is preferably fabricated from an electronically conductive, heat-resistant material such as graphite. When a single electrode is used it must be located centrally within the furnace body and aligned with a vertical axis Y thereof. Alternatively, a plurality of electrodes may be used, in which case the electrodes are arranged symmetrically about the central axis Y. The lower cylindrical portion 16 includes a second, sleeve-type electrode 36 disposed substantially coaxially relative to the elongated electrode 32. The sleeve type electrode is also preferably constructed of a heat resistant and electronically conductive material, such as graphite. The electrodes 32, 36 are adapted be connected to the opposite terminals of a source of electronic power (not shown), the power source typically providing 20 to 200 volts between the two electrodes 32, 36. The application of voltage between the electrodes causes fluidized material to be rapidly heated by direct electronic resistance in accordance with the I²r conversion of electronic energy into heat.

A feed pipe 38 is provided for continuously supplying raw material into the fluidized bed zone 28 of the furnace body 12. As illustrated, the feed pipe 38 is vertically orientated and extends through the top 34 of the furnace body 12, down through the upper cylindrical portion 18, and has its outlet adjacent to the wall either at or below the top of the lower cylindrical portion 16. As such, raw material is introduced from the feed pipe 38 into the fluidized bed, or at least at the top surface thereof, in the area of the downward flow of solid particles being circulated in the fluidized bed. This results in easier loading of raw material into the fluidized bed, reduces the likelihood of the untreated particles being entrained by the upward flow of fluidizing gas and carried into the overbed space, and provides better mixing of the treated and raw materials.

The bottom of the furnace body includes a discharge port 40 through which effluent solids may be continuously withdrawn by gravity flow without need for mechanical devices or moving parts. The discharge port 40 depends from the conical gas distributor 20, with the inlet to the discharge port 40 generally coinciding with the apex of the conical gas distributor 20.

Gaseous effluent can be withdrawn through one or more exhaust pipes or gas flues 42 in the top 34 of the furnace body 12. This effluent gas can be readily cleaned and treated to control particulate and gaseous pollutants as required.

In keeping with the invention, the conical gas distributor 20 includes a plurality of fluidizing gas inlet nozzles 22 (8 shown), through which fluidizing gas is introduced into the furnace body 12. In the context of the process of the present invention, the fluidizing gas is typically nitrogen, argon or other non-reactive gas. The nozzles 22 are orientated so that fluidizing gas forms crossing sprays, with a strong uniform upward flow. As can be appreciated, the velocity at which the fluidizing gas exits the nozzles (“the fluidizing gas rate”) depends on the particle size of the material being fluidized.

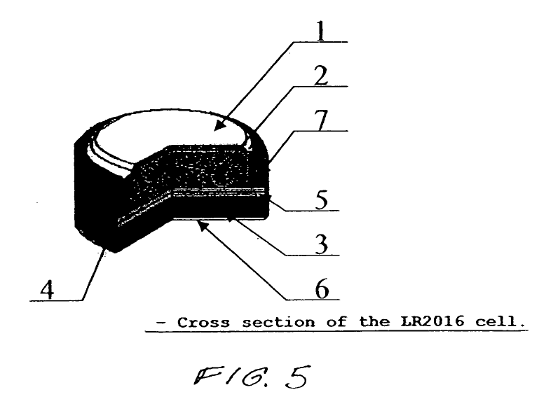

In one embodiment, best seen in FIG. 3, the nozzles 22 are arranged so that their axes X are aligned radially, with the fluidizing gas being directed toward the center of the conical gas distributor 20. Alternatively, and preferably, the nozzles 22 are orientated so that their axes X form an angle β(beta) of from 10 to 20° with respect to the tangent to the conical gas distributor 20 at the location of the nozzle, as best seen in FIG. 4. The arrangement of the nozzles 22 so that their axes X are generally tangential to nozzle circle provides for a rotation of the fluidized bed, making it more stable and less sensitive to any deviation of the elongated electrode 32 from the central axis Y. This also helps to prevent the fluidized particles from being brought into contact with the conical gas distributor 20 at high velocity, which could result in undue wear from abrasion.

In order to prevent the fluidizing gas from interfering or disrupting the discharge of treated particles from the furnace 10, the nozzles 22 are preferably disposed at a heigh H, above the conjunction of the gas distributor 20 and the inlet to the discharge port 40. Preferably, H_{N} is from 0.5 to 0.75 of the total height H_{TC} of the conical gas distributor 20, and more preferably from 0.6 to 0.65 H_{TC}.

Each of the nozzles 22 has a ring diameter perpendicular to its X axis at which is defined a free cross-sectional area. The sum of the free cross-sectional areas of the nozzles 22 should be from 0.15 to 0.5% of the cross-sectional area of the cylindrical portion of the fluidized bed, that is the cross-sectional area of the lower cylindrical portion 16. Preferably, te free cross-sectional area of the nozzles 22 should be between 0.25 and 0.4% of the cross-sectional area of the fluidized bed.

From the foregoing, the method for treating fine particulate materials in the inventive EFB furnace should be self-evident. First, untreated particulate material is continuously feed by gravity through the feed pipe 38 into the reaction zone of the EFB furnace 10. The untreated particulate material may comprise fine, irregularly shaped or polydispersed materials. In pilot runs, the polydispersed material has comprised particles sized from between 1.7 mm (12 mesh), and as small as 5 μm. Further, the untreated particulate may be an electroconductive or semiconductive material, such as carbonaceous materials like carbon black, coke (fluid coke, green flexi-bed coke, delayed coke, etc.), and graphite. The untreated particulate matter is discharged from the feed pipe 38 at the top of, or just inside, the fluidizing zone in the downward flow of particles.

The material from the feed pipe is maintained in a fluidized state in the region of the furnace corresponding approximately to the lower cylindrical portion 16, and electronic current is passed through the fluidized bed to uniformly heat the material to a high temperature, typically from 2,200-2,400° C.

Treated particulate material is continuously withdrawn by gravity through the discharge pipe 40 at about the same rate at which the untreated particulate is introduced. The rate is such that the treatment time of the particulate material within the fluidized bed is sufficient to result in the desired heat treatment. In the use of the present EFB furnace, there is no need for mechanical devices or moving parts within the furnace 10 to effect the discharge of the treated material.

After being discharged through the pipe 40, the treated material may be cooled in a cooling chamber (not shown). In addition, gaseous effluent can be withdrawn through the gas flue 42 at the top 34 of the furnace body 12. This gaseous effluent can be readily cleaned and treated t control pollutants to the extent required.

By use of the inventive EFB furnace and the heat treatment fine particles, significantly better recovery rates (of 90+% in pilot runs) for treated particulate have resulted, in contrast to the recovery rates when using the prior art, bubble-type EFB's, (in which the recovery rate is typically less than 66%). In addition, the critical velocity of fluidization has been reduced over that of a bubble-type EFB furnace from approximately 0.30 ft./sec. To approximately 0.25 ft./sec. In the inventive EFB furnace.

During the heat treatment process, the range of the furnace and thermal process carbon blacks would have been heat treated to within the range 800 to 3000° C. for the purpose of improving their performance properties. In each of the applications described below, following the heat treatment process, the furnace carbon blacks would have a particle size of 7-100 nm and an oil absorption umber of around 50-300 ml/100 g. The thermal blacks would have a particle size of 250-500 nm and an oil absorption number of less than 50 ml/100 g. In each case, the heat-treatment of carbon blacks in the continuous furnace process as described above, substantially removes sulfur, graphitizes the carbon black and makes the carbon black more oxidation resistant. The benefit of these altered properties in various applications is summarized in Table 1, entitled “Matrix of Carbon Black Properties Imparted as a Result of Thermal Modification and Their Effect on Various Applications” and will be described in detail as follows:

Thermally Modified Carbon Black for Moisture Cured Polymer Systems

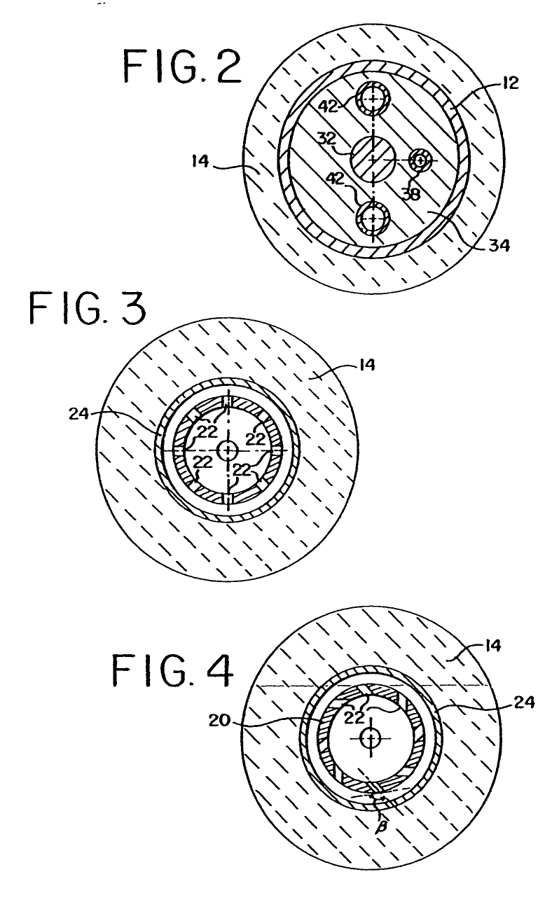

Reference is made to Table 2 where there is illustrated moisture pickup data for as-is (non heat-treated) and heat-treated carbon blacks utilizing the heat treatment process of the present invention, utilizing the type of furnace 10 as was described in reference to FIGS. 1-4. As is seen clearly in Table 2, there are provided a group of four carbon blacks which are displayed as non-treated and heat-treated blacks, and comparing the moisture pickup of each of the carbon blacks both after one hour and at equilibrium. It is clear from the results as provided in Table 2 that the heat-treated blacks have a significantly lower percentage moisture pickup than the non-treated carbon blacks. For example, the untreated thermal black had 0.18% moisture pickup after one hour, where the heat-treated thermal black resulted in a 0.02% moisture pickup over the same time frame. These significant differences in the percentage moisture pickup, as seen in Table 2, apply for the other carbon black samples; namely CDX-975U(2.41% untreated; 0.17% treated); N220 (1.48% untreated; 0.08% treated); N330 (0.6% untreated; 0.02% treated). Comparable results are illustrated in the column labeled “Equilibrium Moisture Pickup (%),s seen in Table 2. Each of the carbon blacks referred to in Table 2, both treated designations and untreated designations, are carbon blacks produced by Columbian Chemicals Company.

Metallic impurities (salts) in carbon black can also contribute to moisture pick-up. Table 3 illustrates the reduction in metal and ash contents of the carbon blacks (N220 and N330) upon heat-treatment.

As previously discussed in the background section, these reductions in moisture pickup properties provide significant advantages in the manufacture of moisture cured polymer systems and in wire and cable applications.

Thermally Modified Carbon Black for Semi-Conductive Wire and Cable Applications

In the background of the invention, reference is made to the fact that carbon blacks are used in insulated electric power cable semiconducting shields. Acetylene carbon black is commonly used to provide the superior interfacial smoothness in semiconductor compounds. However, this type of black is difficult to produce and process compared to furnace carbon blacks. In utilizing the process for heat treating carbon blacks as was described in reference to FIG. 1, thermally modified furnace carbon blacks were produced which provide compounds with interfacial smoothness at least equivalent to that obtained with acetylene carbon black. Furthermore, thermally modified carbon blacks are easy to process and provide better conductivity and melt flow properties. In addition, thermally modified carbon blacks can be produced with a much broader range of morphologies as compared to acetylene black and have lower moisture absorption characteristics, which is a highly desirable property in semiconductor compounds.

Reference is made to Table 4 entitled “Colloidal Properties.”Table 4 compares three different blacks: CDX-975U, (a furnace carbon black used in semiconductive compounds acetylene black, and CDX975U which was heat treated according to the heat treatment process as described above, at approximately 2,000 degrees centigrade. In comparing the various properties of the three carbon blacks, it should be noted, for example, that the iodine value (mg/g) of the heat treated black is 98.8. The NSA (m²/g) is 71.9. The DBPA (ml/100 g) is 156.8. The sulfur content is 0.01%. The pH is 10.6 and the moisture percentage is 0.0. It is clear from Table 4 that when comparing the heat treated carbon black with the acetylene black, the colloidal properties are very similar, however, the heat treated carbon black can be provided over a wide range of morphologies and hence is more versatile and desirable product.

Four samples of very high structure furnace and acetylene blacks were analyzed for oil absorption number (OAN) and compressed oil absorption number (COAN) using paraffin oil. The results shown in Table 5 indicate the Shawinigan acetylene black exhibits the least stable structure. The two heat-treated samples of CDX-975U are much more stable compared to the acetylene black. The stability of aggregate structure would contribute to higher in-compound conductivity and better processability of these carbon blacks.

Turning now to Table 6, which is entitled Moisture Pickup (MPU) and Melt Flow properties at 30% loading in 10MI LDPE. The same three blacks are compared for their MPU properties and melt flow index when compounded at 30 wt % loading in IOMFI LDPE. As noted for the uncompounded heat treated black, the MPU at one hour is 0.17%; and the equilibrium MPU is 0.27%; the equilibrium MPU of the compound is 0.01%; and the melt flow index (g/10 ml) is 7.0. Again, when comparing these values against the properties of the two untreated blacks, it is clear that the properties of the heat treated carbon black are more desirable, and therefore provide a more viable product. For the melt flow index it should be noted that there was 10 kilogram load at 190 degrees centigrade.

Reference is now made to Table 7 where there is illustrated the volume resistivity versus the processibility in polyethylene of the two blacks, namely, the acetylene black, and the heat treated CDX-975U. As is indicated in the Table 7, which is a graph of the melt flow in gm/10 min against the log volume resistivity in Ohms cm, it is clear that the heat treated carbon black has a much lower volume resistivity in Ohms cm than the other carbon black.

Next, the combustion rate of as produced and heat treated CDX 975U were compared at 450-650 degrees centigrade in both pure oxygen and air using a thermogravimetric technique. Reference is made to Table 8, for the combustion rates (expressed in terms of percent weight loss per minute). These were estimated from the first derivative of the thermograms.

The combustion rate reduces while the activation energy for combustion increases as a function of heat treatment. The CDX-975U was thermally treated at a temperature of 2000 degrees centigrade.

The samples were first heated to the target combustion temperature and equilibrated for 10 minutes under inert atmosphere followed by switching to either pure oxygen or air for two to four hours. The activation energy for combustion is calculated from the slope of arrhenius plots and is given also in Table 8. The heat treated carbon black samples are seen to have a higher activation energy than that of the CDX-975U control.

Relevant Test Methods

Sulfur. The method used in the determination of the total sulfur content of carbon black involves a carbon black sample combusted in an oxygen enriched atmosphere in order to convert any sulfur present into SO2. The SO2 is then detected and quantified by infrared detection. This is set forth in “Standard Test Methods for Carbon Black-sulphur Content”, in the book ASTM Standards, Vol. 9.01, Method 1619, part C-94.

The sulfur content of the carbon black is directly related to the sulfur level of the feedstock oil. Most feedstock oil available contains a relatively high sulfur level, typically greater than 2%. The majority of sulfur in carbon black is chemically combined and not reactive. However, even small quantities of sulfur species can have significant effects in a variety of rubber and industrial applications.

One Hour and Equilibrium Moisture Absorption of Compounded Plastic

The granulated plastic compound is dried in a vacuum oven at 80+25° C. overnight and allowed to cool, followed by transferring the sample to a controlled humidity chamber (humidity=71+3% and temperature=23+2° C.). The sample is weighed at regular intervals (every 15 minutes for first 1 hour, then every 4 hours for next 24 hours an then every 24 hours) in order to determine the moisture pick-up of the compound, the process typically takes over 100 hours. The equilibrium moisture absorption of the compound is determined from graphical treatment of the data. The tendency of carbon black to adsorb atmospheric moisture after being compounded into plastics can affect the properties of the plastics during processing.

One Hour and Equilibrium Moisture Absorption of Carbon Black

This procedure is applicable to all carbon blacks whether in power or beaded form.—the sample is dried under vacuum (1 mm of Hg or less) at 100±25° C. for at least 4 hours. The sample is removed from the vacuum system while still under vacuum and transferred to a glovebox at controlled temperature and humidity (humidity=71+3% and temperature=23+2° C.). The vacuum is removed and the black is immediately transferred to a preweighed aluminum dish and the carbon black is weighed. The sample is weighed at regular intervals (eery 15 minutes for first 1 hour, then every 4 hours for next 24 hours and then every 24 hours) in order to determine the moisture pickup. The equilibrium MPU for a carbon black is typically measured at regular intervals over a one week period. The amount of moisture absorbed by a black is influenced by several physical and chemical characteristics of the carbon black.

Thermally Modified Carbon Black for Use in Food Contact-Type Applications

Carbon blacks are used quite often as colorants for polymers in producing, manufacturing, packing, processing, preparing, treating, packaging, transporting or holding food under all temperatures. Typical furnace blacks have PAH levels that are higher than allowed under the FDA regulations. There are a very limited number of furnace carbon black grades available that meet the FDA limits. However, these grades are of only limited morphology. Channel blacks which are also used in such applications are exempt from the FDA regulations, but are also increasingly difficult to access. In addition they have very poor processing characteristics. As will be discussed in this section, the thermally modified carbon blacks of the present invention possess the necessary properties to meet all FDA guidelines for food contact applications, including lower PAH levels within limits that are allowed under the FDA regulations.

In this application in the present invention, there is utilized a continuous heat treatment process as disclosed herein, for thermally modifying any grade of furnace or thermal carbon black in order to meet the FDA guidelines for food contact type applications. The advantage of this process is that it provides a user with the flexibility of using any carbon black dictated by requisite performance properties just as jetness, viscosity/processing, dispersion, impact strength, etc. that may be critical for the intended application. This flexibility in morphology will also allow for carbon black filled polymer master batches to have loadings greater than 40% which has not been achieved thus far for FDA compliant carbon blacks. Addressed herein is the effective heat treatment of carbon blacks to reduce PAH (polycyclic aromatic hydrocarbon) content to levels which meet FDA compliance limits. N700 series and CDX-975U carbon black products of Colombian Chemicals Corporation are presented as examples. A FDA-compliant Gas Chromatography-Mass Spectroscopy (GC-MS) method has been successfully developed for analysis of PAH (polycyclic aromatic hydrocarbon) contents of CB for food contact applications. This method was used to assess the ability of a special heat treatment technique to reduce the PAH content of carbon black.

Polycyclic Aromatic Hydrocarbon (PAH)

Carbon blacks are invariably formed in a high temperature gas stream, a process involving pyrolysis. Such pyrolysis of carbonaceous raw material results in aromatization (ring formation). During the process of carbon black formation it is possible that the ring formation may lead to condensation of these aromatic rings, yielding PAH compounds that may be retained within the carbon black.

FDA Food Addition Regulation

The high-purity furnace blacks that meet the FDA regulation are those containing a total of 22 specified PAH compounds (see Table 9) not exceeding 500 ppb (parts per billion) and benzo(a)pyrene not exceeding 5 ppb. The method for determination of PAH content is gas Chromatography Mass Spectrometry (GC-MS).

Food Contact Testing of Carbon Black

Heat treatment of CB at high temperatures produces a dramatic effect on the surface properties of CB. The PAH content of heat-treated CDX-975U, N700 series and the untreated N700 series carbon blacks were determined using the FDA-compliant GC-MS test protocol. The results are summarized in Table 10. A Competitive FDA compliant carbon black was included in the study for comparison.

It is evident that the PAH impurities of the N700 Series carbon blacks are profoundly reduced (≃1000×) by the heat treatment. The total PAHs and BaP content of heat treated N700 series and CDX-975U carbon blacks are extremely low and meet the FDA food additive application regulation. The heat treatment results in a CDX-975U that greatly exceeds the purity (low PAH) of competitive products. Note that the CDX-975U was heat treated at 2000° C.

To further reinforce the general applicability of heat treatment on PAH reduction, results on two additional product grades are presented in Table 11.

### Thermally Modified Carbon Black for Use in the Electrochemical Power Sources

### EXAMPLES

Under this area of application for heat modified carbon black, we describe examples of test results in the Zinc-carbon and alkaline cells. There are similarities between the above and other battery systems, which allow us to extend our claims to a great many other battery systems, which are listed later.

### Example #1

### Zinc-Carbon Dry Cell Applications

Carbon blacks arc used in dry nell (zinc-carbon batteries). The application for the carbon black is in both the positive electrode and in carbon rods of this battery system.

In this application in the present invention, there is utilized the continuous heat treatment process as disclosed therein, for thermally modifying a range of furnace carbon blacks by heat treating to 800-3,000 degrees centigrade for the purpose of improving their performance properties in dry cell batteries.

In the battery mockup test results work (performed at Center for Energy Research at SPIC Science Foundation, India) reported, all the tests were carried out at 25 mA 50 MA and 100 mA discharge current and the results are given in Table 12. The composition of the cathode was maintained at MnO2 (87.5%)+Graphite (2%)+carbon sample (10.5%)+ZnCl₂ (30%).

The capacity of all the samples tested are higher at this lower discharge current. However the trend w.r.t. to sulfur content is similar: the samples which have lower sulfur content give better cathode capacity compared to samples which have higher sulfur content.

In conclusion, from the aforesaid results it is clear that the treatment process used for thermally modifying the carbon blacks produces carbon blacks of excellent properties.

### Example #2

### Heat Treated Carbon Black in Alkaline Cells

In order to prove a concept of the increased conductivity of the carbon black upon its heat treatment, the alkaline cells of the electrochemical system Zn/KOH/MnO₂ have been built and tested. The findings are reported herein.

The electrochemical cells of the alkaline Zinc-manganese dioxide system (LR2016 size) have been manufactured and tested at the Superior Graphite Co. The abstracts below describe battery design and the procedures used by authors for manufacturing and testing of batteries.

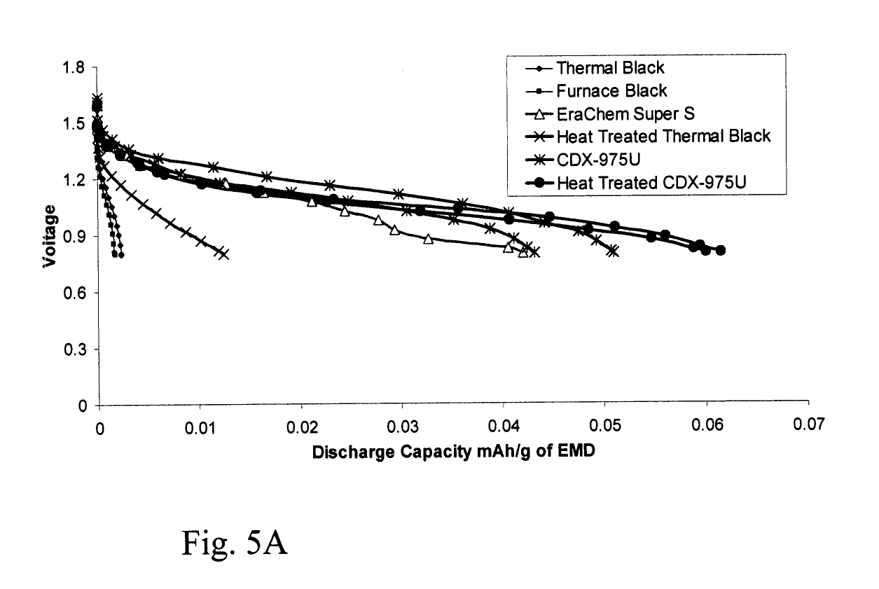

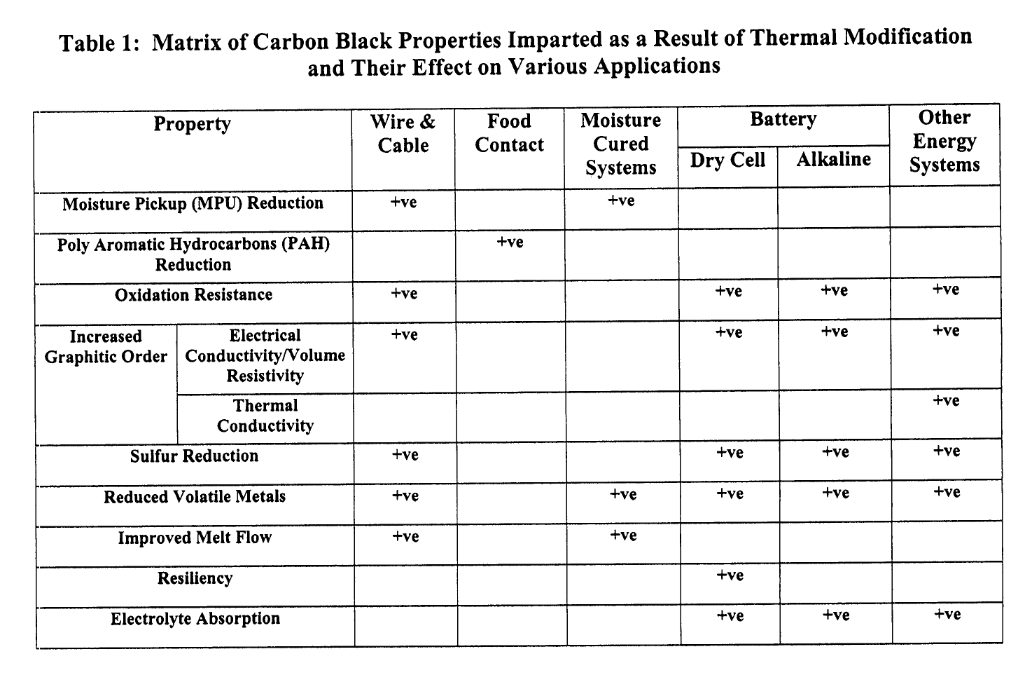

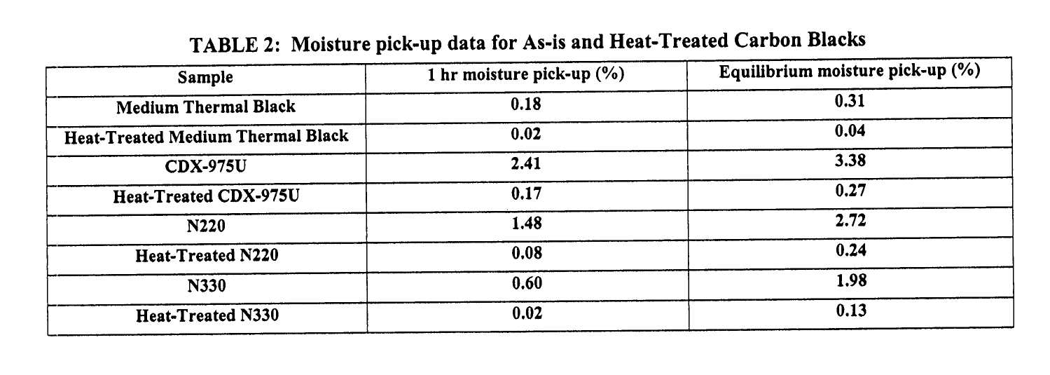

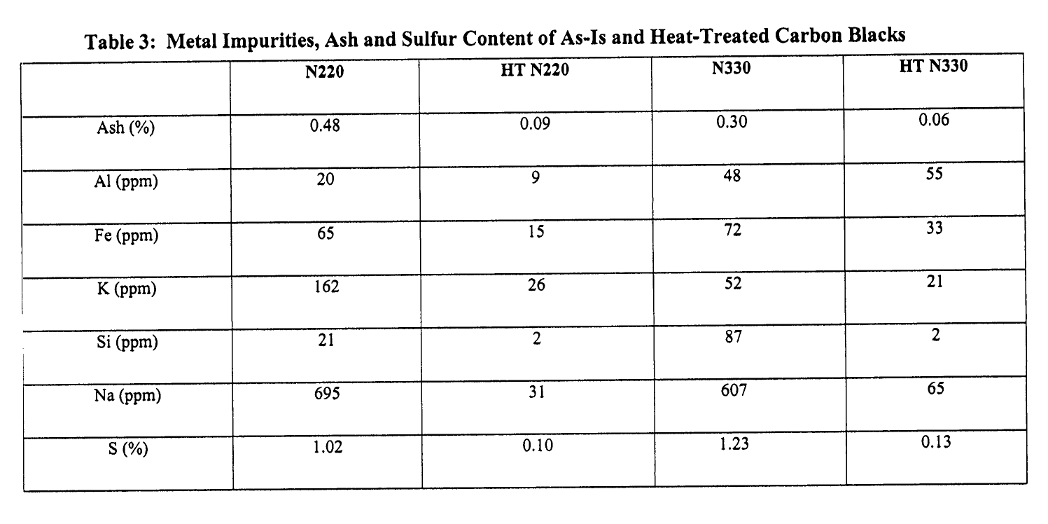

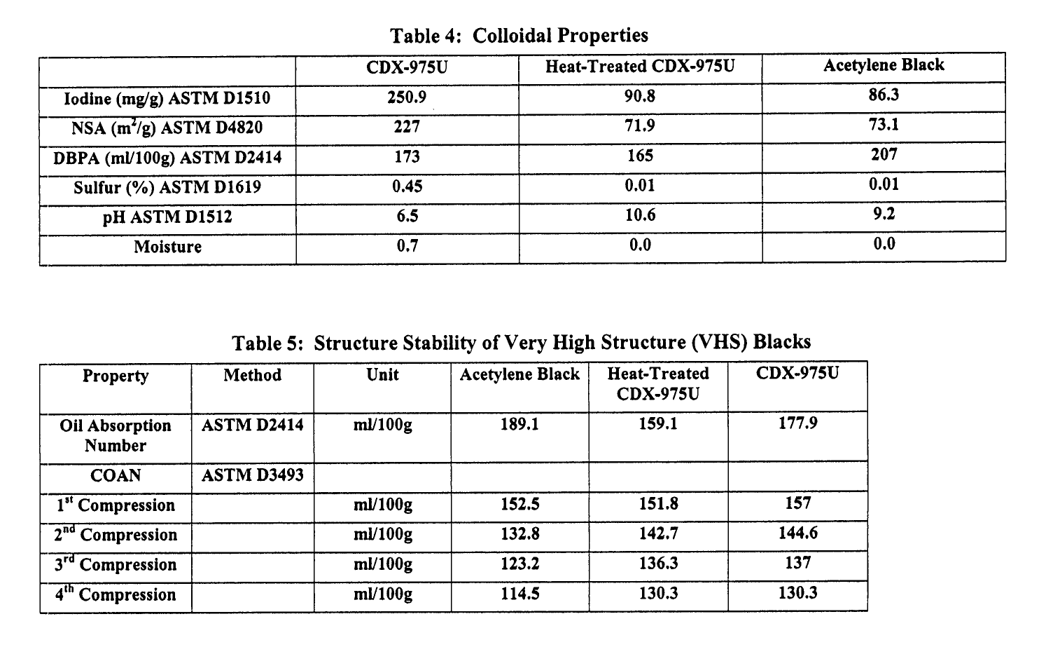

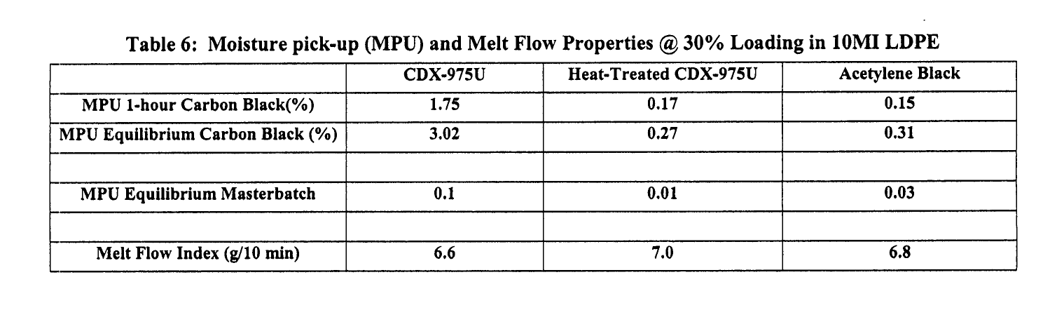

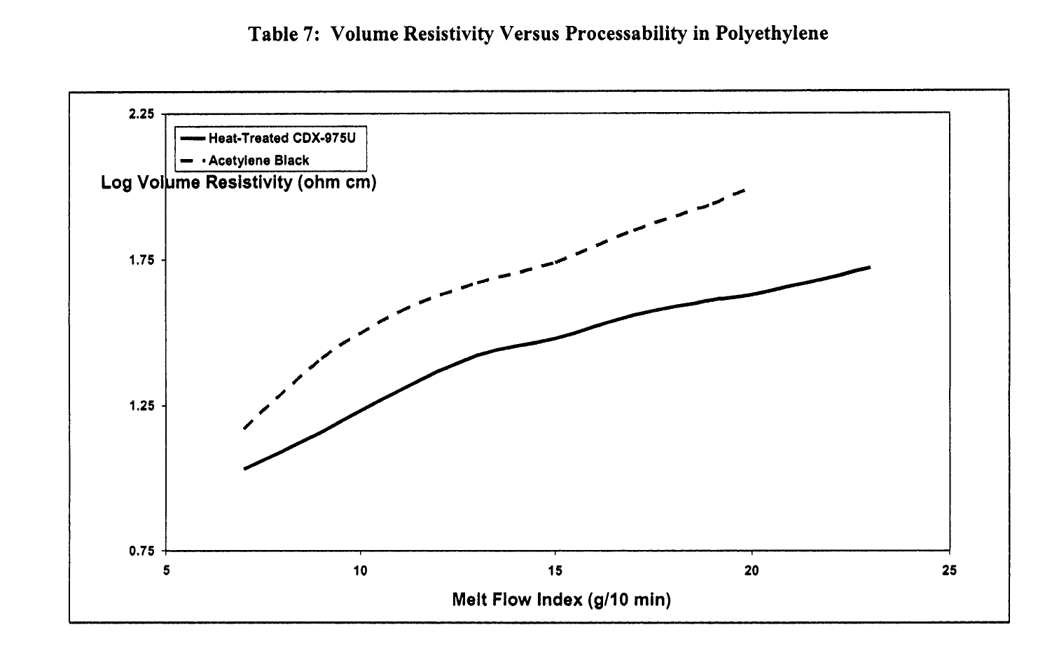

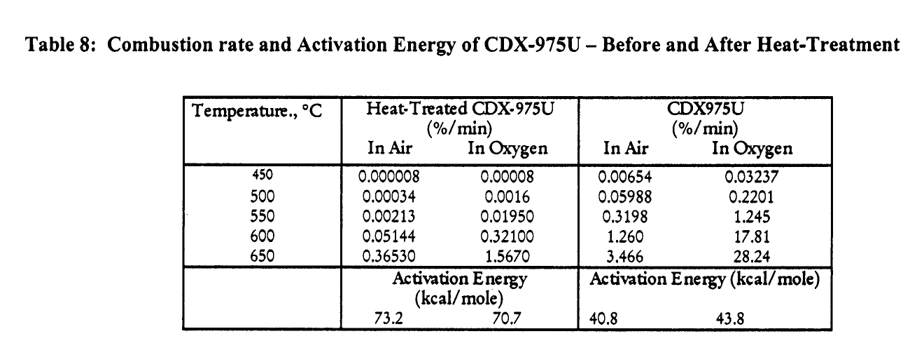

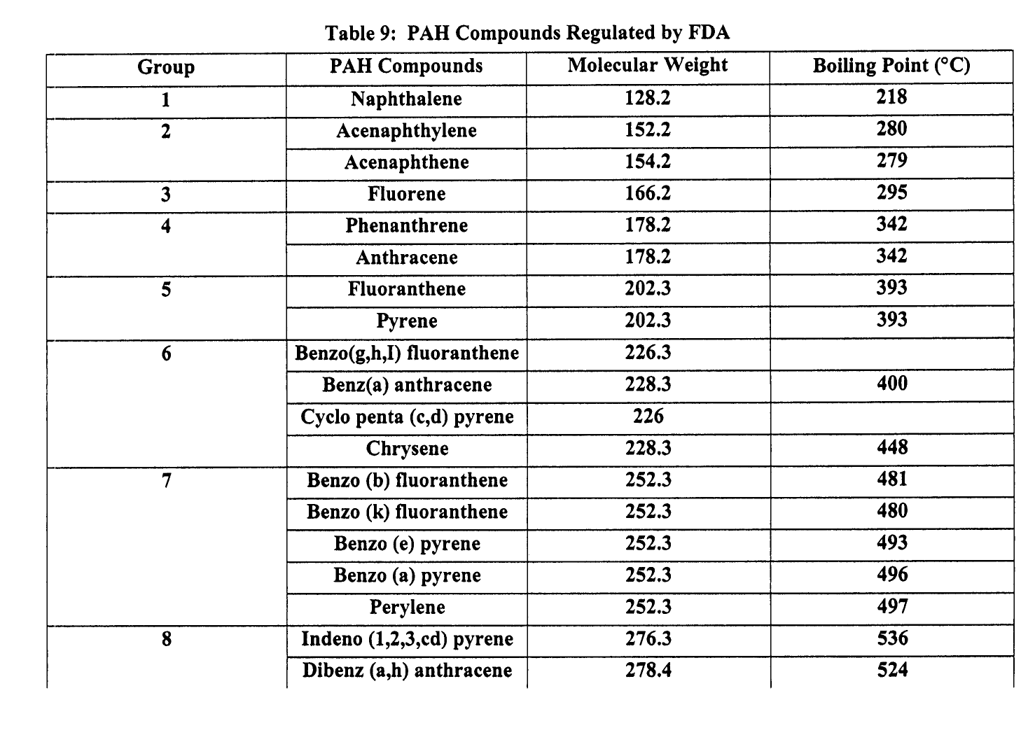

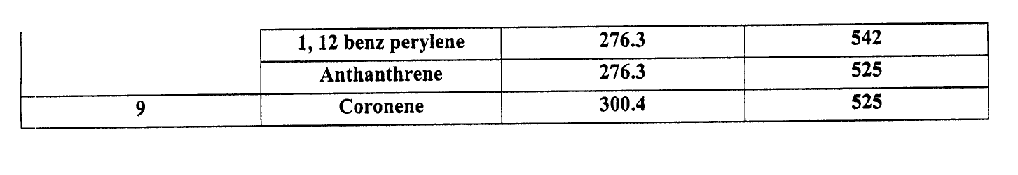

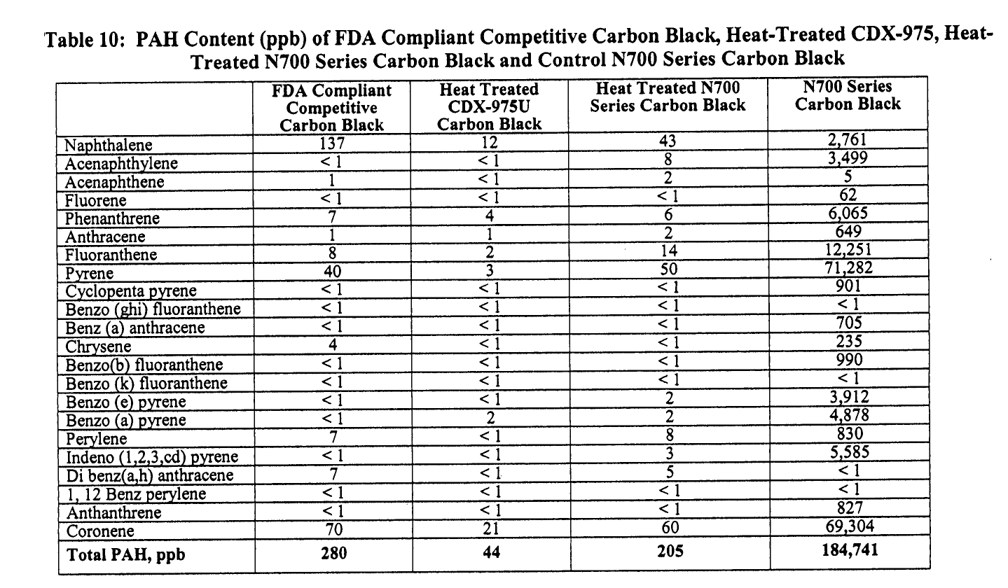

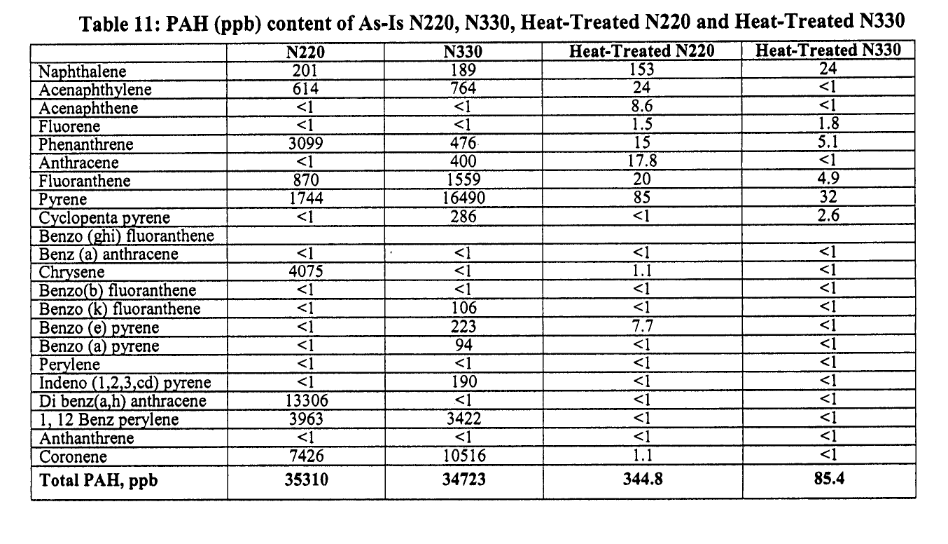

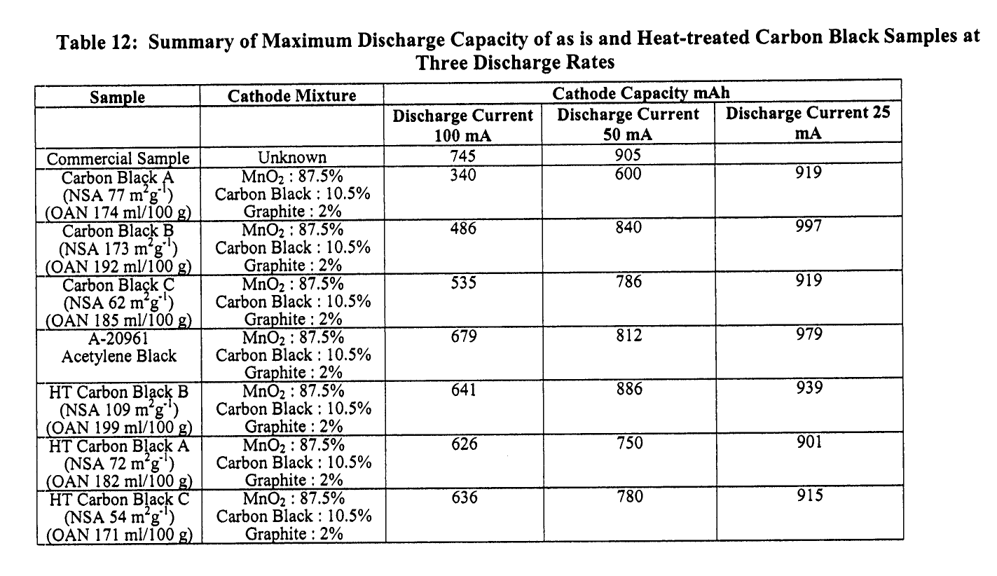

The typical electrochemical device used for testing was a coin cell of a standard 2016 size (20 mm diameter and 1.6 mm high), please see FIG. 5. The stainless steel housing for such cells is available from Hoshen, a Japan corporation. FIG. 5 schematically represents the cutaway view of the cell. The construction of such cells can be referenced to the published literature¹.
¹D. Linden. Handbook of Batteries and Fuel Cells./McGraw-Hill Book Co., Inc., New York, 1995, P. 10.10.

The battery shown in FIG. 5 consists of the following main components. Stainless steel anode cup (1), cathode cup (6) and a nylon gasket (7) represent a housing of the battery. The interior of the cathode cup is airbrushed with graphite containing can coating (4). Such coating, for instance, is available from Superior Graphite Co., and is called “Formula 39A”. The cathode (3) consists of the active material, EMD. An example of such material is AB—standard alkaline battery grade available from Kerr McGee, a US company. For the electrochemical data reported the amount of EMD in the cathodes was either 0.35 g or 0.3 g. There was a carbon black powder, which has been added for conductivity enhancement purposes to the EMD. The amount of carbon will depend on the purpose of the test. Herein we report data for EMD/Carbon ratios of 20/1. The wet cathode mix (impregnated with electrolyte, 31 wt % or 37 wt % KOH) is pressed into the pre-coated with (4) and dried cathode cup. The pressure is applied by a semi-automatic hydraulic press, which is available from Carver, Inc., a US manufacturer. The pressure of about 4,210 lbs/cm² is applied during 30 seconds to form the cathode pallet. The final electrode thickness is monitored and controlled as a measure of density of the electrode. Two layers of the Zr cloth separator (5) available from ZirCar, a US company, are placed between cathode and anode (2). As an alternative, two layers of the non-woven separator may be used. The separator is impregnated with KOH electrolyte prior to placing it in the battery. The anode (2) is based on Zinc powder, available from Doral Distribution, a Swiss company (grade: Zinc Doralloy 104<0.036 mm). Its amount is balanced to be equal to the amount of EMD in the counter electrode. The anode paste as well is impregnated with KOH electrolyte prior to assembling of the cell. The battery is sealed by the means of a crimping device available for this type of cells from Hoshen Corp. of Japan.

In order to make conclusive statements, the authors made up to twenty cells of each formula. Freshly made cells are being discharged using multi-channel battery cycler, for instance, a 16-channel model available from Arbin Instruments, a US company. The current densities applied to the cells are described in detail in the “examples” chapter.

Although, majority of the tests, reported herein describe performance of the conventional and heat modified carbon blacks, in the alkaline Zinc-Manganese dioxide primary batteries, authors believe that similar increased performance of other batteries using the materials under consideration will hold true. This assumption is based on some accomplished studies with other-than-alkaline battery systems, as well as due to existing similarities for the conductivity enhancement mechanisms, which are known for many other battery systems. In particular case, authors expect thermally modified carbon blacks to work more efficiently than other conventional graphites in the zinc-air “hearing aid” primary batteries, Li-Ion and Li-Ion polymer secondary batteries, industrial nickel cadmium rechargeable batteries, reserve cells, electrochemical ultracapacitors, fuel cells, and other power sources.

Reference is made to the enclosed chart (FIG. 5A) containing the discharge curves of the five samples of carbon black. These samples were as follows:
Sample of thermal carbon black produced by Columbian Chemicals Co. that had been heat-treated to 2400C for 60min (heat treatment cycle performed by Superior Graphite Co.);
Sample of as-is thermal black produced by Columbian Chemicals Co.;
Furnace Black used by Superior Graphite Co. on the furnaces in KY and ARK.;
Carbon black sample of Super S from Erachem Comilog, a Belgium company.;
Sample of heat-treated CDX-975U;
Sample of as-is CDX-975U.

Each one of these samples has been reduced in size by brushing (forcefully) through a 200 mesh screen.

FIG. 5A illustrates the Galvanostatic discharge curves for LR2016 batteries having various carbon blacks and/or their heat treated versions.

Curves for the two most typical cells of each formula are shown.

One can see from the graph on FIG. 5A that heat-treated thermal black offers at least a 5 times better conductivity enhancement efficiency than the as-is thermal black. The as-is and heat-treated thermal blacks are plotted in comparison with a Furnace Black used on the furnaces in KY and ARK. The similarities between the as-is thermal black and the furnace black are obvious. After graphitization, a 5 times better performance of carbon black is achieved. In general, Furnace Black is known to be more insulating than conducting, hence we did not expect even its heat-treated version to outperform high structure carbons Super S, as-is CDX-975U and heat-treated CDX-975U.

On the same graph, a Super S grade of carbon black from Erachem, which is known to give a high capacity in batteries and performs as well as expanded graphite (GA-17, a product of Superior Graphite Co. and the state of the art conductivity enhancement additive for the alkaline batteries of this electrochemical system) is compared with performance of Columbian Chemicals' as-is CDX-975U and its heat-treated version. As derived from FIG. 5A, heat-treated CDX-975U containing cells show the record for highest discharge capacity by a wide margin. It is noteworthy that its precursor, CDX-975U, due to its high surface area (˜170 m2/g) demonstrates higher average discharge voltage of the cells than the batteries containing heat-treated CDX-975U (surface area is 68 m2/g). At the same time, CDX-975U cannot be used due to its high affinity to enter in the thermodynamically unstable reaction with MnO₂ partially because of its high surface area.

### Example #3

### Resistivity and Springback Characteristics of the Heat Treated and Ungraphitized Carbon Black Powders for Use in Energy Applications

In the tables below we list surface areas, resistivities and resiliencies of carbon black powders before and after graphitization. All 3 physicochemical properties are of great importance for electrochemical applications. The description of test methods is provided below.

In accordance with the “Resiliency” (Percent expansion) test, a sample is compressed between two plugs within a cylindrical mold. This mold assembly is subjected to a loading of 690 bar (10,000 psi). When stable at this loading, the height of the assembly is measured. The load is then released and the assembly allowed to expand vertically until a stable height is reached. The percentage increase in height over the original compacted height is calculated.

As can be seen from the tables below, the resiliency change upon heat treatment is noticeable. Ability to change it is important for processing of power sources' electrode mixes.

In accordance with the Electronic Resistivity test, A specific size fraction and volume of sample is confined under load in a non-conductive cylindrical mold by two metal electrodes. Unidirectional resistance is measured between these electrodes using a Kelvin bridge. Resistivity is calculated and reported Ohm-inches.

In batteries and other power sources, as high as possible conductivities (as low as possible resistance) is needed. All heat treated samples, which are shown in the tables below display increased conductivity after heat treatment, probably due to the higher degree of graphiticity than that of precursors.

TABLE
Comparison of characteristics of furnace carbon black and its
thermally treated versions.

| | | | | Heat | | |
|---|---|---|---|---|---|---|
| | | | N700 | Treated | | |
| | | Heat- | Series | N700 Series | | Heat- |
| Sample | | Treated | Carbon | Carbon | | Treated |
| No. | HV-3396 | HV-3396 | Black | Black | CDX-975U | CDX-975U |
| Trial No. | Run 454 | 800 deg. | Run 1615 | 1500 deg | Run 446 | 2150 deg. |
| | IRM | | IRM | | IRM | |
| Surface Area | 165.70 | 145.00 | 33.10 | 32.90 | 205.30 | 63.70 |
| (m\hat{ }2/g) | | | | | | |
| Resistivity | 0.2523 | 0.1753 | 0.1730 | 0.0735 | 0.1277 | 0.1020 |
| (ohm in.) | | | | | | |
| Resilliency | 36 | 42 | 22 | 32 | 61 | 81 |
| (%) | | | | | | |

Analysis of the results in the above table suggests that the surface area of carbon generally goes down upon its heat treatment. Reduction of surface area is believed to be associated with the reduction of the amount of the surface active groups, which usually limits side reactions occurring in electric and electrochemical applications. In applications, where the heat treated carbon black has to go into slurries, higher percent loading can be achieved, which is usually provides easier processing. Through extensive experimentation, we have produced heat-treated carbon blacks with a surface area of 6 through 70 m2/g.

Also, analysis of the results in the above table suggests that the conductivity of heat-treated carbon black goes up as compared with a feed material. Increased conductivity is an ultimate goal of nearly every carbon containing coating, electrode, assembly or other application. The resistance of carbon black of below 0.17 Ohm-inch as determined in accordance with the earlier devised method, is believed to be offering a uniqueness to heat treated carbon black and therefore is claimed herein.

Analysis of the results in the above table suggests that the value of resilience of the heat treated carbon black goes up and, based on our findings, can be controlled in the range 40-200% (the examples in the table refer to the range of 42-81%).

### Example #4

### Other Electrochemical Power Sources and Electronic, Etc. Applications

Benefits seen in the above two examples should extend for numerous other electrochemical power sources, electronic and stop loss fluid applications.

By utilizing the process of manufacturing the heat-treated, partially graphitized carbon black, as disclosed herein, it is foreseen that the resulting product, which may be referred to and described hereafter as PUREBLACK™, which is a trademark jointly owned by Columbian Chemicals Company and Superior Graphite Co., and because of the properties of the product which allows it to be used over a wide range of electrochemical and electronic applications, will have applications particularly in the portable and stationary energy systems outlined with specifics as follows:

Thermally enchanced carbon black could find wide use in a number of stationary and portable power sources. Its application can be split into the six major groups, which are described below:
1. Thermally enchanced carbon black carbon additives; which enhance electronical conductivity of battery active materials.
2. Partially graphitized thermally enhanced carbon black as electrode active material.
3. Thermally enhanced carbon black as a catalyst of chemical and electrochemical reactions in batteries.
4. Thermally enhanced carbon black as battery assembly components.
5. Thermally enhanced carbon black as an ingredient of the coatings used in power sources.
6. Thermally enhanced carbon black as an ingredient of the electronical resistance dependent applications.

The thermally enhanced carbon black could be used in any of the above applications alone, or in combination with any type and quality of graphite and/or carbon black, and/or other chemicals. The thermally enhanced carbon black carbon used in the above applications processed together with other materials or deposited onto, or smeared into them. The thermally enhanced carbon black carbon will have application specific spec ranges, which are not fully known at this time.

Examples, which are to be mentioned in the applications mentioned above:

Application examples for thermally enhanced carbon black additives, which enhance electronical conductivity of battery active materials:

Zinc-carbon primary batteries; Magnesium and Aluminum primary batteries; Alkaline Manganese Dioxide batteries; Mercuric oxide batteries; Silver oxide batteries; Zine-air batteries (bottom and cylindrical configurations); Lithium batteries (Lithium/Sulfur Dioxide Primary batteries, Lithium/Thionyl chloride primary batteries, Lithium/Oxychloride batteries, Lithium/manganese dioxide batteries (primary and rechargeable), Lithium/carbon monofluoride batteries, Lithium/Iron disulfide batteries, Lithium/Copper oxide batteries, Lithium/copper oxyphosphate batteries, Lithium/Silver vanadium oxide primary and secondary batteries; Solid electrolyte batteries (Li/LiI(A1203)/metal salt batteries, Lithium-Iodine batteries; Ag/RbAg415/Me4Nin, C batteries); Reserve batteries (Magnesium/water activated batteries, Zinc/Silver Oxide reserve batteries, Spin-dependant reserve batteries, Ambient temperature Li anode reserve batteries, Thermal batteries); Secondary batteries (Lead/Acid batteries, Iron electrode batteries, Nickel Cadmium batteries (industrial, aerospace and consumer (portable sealed NiCd)), Portable sealed Ni-MH batteries, Propulsion and industrial Ni-MH batteries, Ni-Zinc batteries, Ni-Hydrogen batteries, Silver oxide batteries); Rechargeable Li batteries of the ambient temperature (Lithium-Ion batteries, Lithium-Ion Polymer Batteries); rechargeable Zinc/Alkaline/Manganese Dioxide Batteries; Advanced Batteries for Electric Vehicles, Hybrid Electronic Vehicles and emerging applications (Metal-air batteries, Zinc-Bromine batteries, Sodium-Beta batteries, Lithium/Iron Sulfide batteries), Fuel Cells (portable and stationary of all types), electrochemical ultracapacitors (supercapacitors), double layer capacitors.

Application examples for Partially graphitized thermally enhanced carbon as electrode active material. As part of the composition or as a stand alone material in negative electrode active material of the Lithium-Ion, Lithium-Ion polymer batteries, metal-free and semi-metal batteries.

Application examples for thermally enhanced carbon black as a catalyst of chemical, electrochemical and charge transfer reactions in batteries.

Zinc-Air primary and rechargeable batteries, gas diffusion layer of the fuel cells of all types (portable and stationary), gas diffusion electrodes of other power sources systems (e.g. electrochemical sensors, etc.)

Application examples for thermally enhanced carbon black carbon as battery assembly components and “processing aid” additives. Current collectors of the metal-free, semi-metal batteries, fuel cell separator plants, carbon rods of the Zinc-Carbon primary batteries, additives to the negative and positive electrodes of the Lithium-Ion and Lithiuim-Ion polymer batteries, mono-valent and divalent silver oxide batteries, Ni—Cd and Ni-MH batteries with sintered electrode design, parts of assembly of the carbon-carbon composite batteries.

Application examples for thermally enhanced carbon black as an ingredient of the coatings used in power sources. Carbon coating of: the double layer electronic capacitors, electrochemical ultracapacitors “supercapacitors” Zinc-carbon batteries; current collector substrate coating of: Lithium-Ion polymer cathodes and anodes, Lithium-Ion batteries with liquid electrolyte (foil coating for positive and negative electrodes), Zinc-air primary and rechargeable batteries, can coating of the Zinc Alkaline Manganese Dioxide primary and rechargeable batteries.

Application examples for thermally enhanced carbon black as an ingredient of the electronic resistance dependent applications. Ingredient of the microphones, resistors, strain-, temperature- and current-sensitive resistors. TV tube and “black matrix” coatings. The thermally enhanced carbon black application for stop loss circulation well and oil drilling market to be used as is or together with other stop loss additives, including but not limited to graphite, other forms of carbon black, glass beads, etc.

The foregoing embodiments are presented by way of example only; the scope of the present invention is to be limited only by the following claims.

1. Thermally modified carbon blacks comprising a particle size of between 7 nm to 500 nm and an oil adsorption number between 30 to 300 ml/100 g, the carbon blacks produced by a continuous electrothermal furnace treatment process.

2. The thermally modified carbon blacks in claim 1, wherein the carbon blacks comprise thermal carbon blacks and furnace blacks.

3. The thermally modified carbon blacks in claim 1, wherein the process comprises:
a. providing an electro thermal furnace, a portion of the furnace defining a fluidizing zone, and a second portion defining an overbed zone; a plurality of nozzles for introducing fluidizing gas into the furnace;
b. introducing a non-reactive fluidizing gas through the nozzles so that the gas define an upward flow in the furnace;
c. introducing untreated carbon black material into the furnace at a predetermined rate so the carbon black forms a fluidized bed;
d. energizing an electrode in the furnace to heat the fluidized bed; and
e. continuously collecting the treated carbon black from a furnace discharge pipe.

4. The thermally modified carbon blacks in claim 1, wherein the heat treated carbon black is used in food-contact type applications.

5. The thermally modified carbon blacks in claim 1, wherein the heat treated carbon black is used in moisture cured polymer systems applications.

6. The thermally modified carbon blacks in claim 1, wherein the heat treated carbon black is used in zinc-carbon dry cell battery applications.

7. The thermally modified carbon blacks in claim 1, wherein the heat treated carbon black is used in semi-conductive wire and cable applications.

8. The thermally modified carbon blacks in claim 1, wherein the heat treatment takes place at between 800 to 3000° C.

9. The thermally modified carbon blacks in claim 1, wherein the heat treatment removes sulfur, graphitizes the carbon black, reduces PAH content, reduces volatile metal content, and minimizes the moisture pick-up by carbon black.

10. The thermally modified carbon blacks in claim 1, wherein the carbon blacks comprise the carbonaceous material in the formulation of the electrode for an electrochemical power source.

11. The thermally modified carbon blacks in claim 1, wherein the carbon blacks comprise, in combination with any other carbonaceous materials, 0.01 to 8 wt % of the total amount of carbonaceous materials.

12. The thermally modified carbon blacks in claim 1, wherein the carbon blacks comprise amounts of 0.01 to 8 wt % of the total amount of materials in a drilling mud formulation for oil field applications.

13. The thermally modified carbon blacks in claim 1, wherein the carbon blacks comprise the carbonaceous material in the formulation of a cathode ray TV tube coating.

14. The thermally modified carbon blacks in claim 1, wherein the carbon blacks are used in amounts from 0.01% to 99.9% of the total amount of carbonaceous materials in the formulation of a cathode ray TV tube coating.

15. The thermally modified carbon black in claim 1, wherein the carbon blacks are used as the carbonaceous material in the formulation of an electrically conductive coating.

16. The thermally modified carbon blacks in claim 1, wherein the carbon blacks are used in amounts from 0.01% to 99.9% of the total amount of carbonaceous materials in the formulation of an electrically conductive coating.

17. Thermally modified carbon blacks comprising a particle size of between 7 nm to 500 nm and an oil adsorption number of between 30 and 300 ml/100 g, the carbon blacks produced by a continuous electrothermal furnace treatment process comprising the following steps:
a. providing an electro thermal furnace, a portion of the furnace defining a fluidizing zone, and a second portion defining an overbed zone; a plurality of nozzles for introducing fluidizing gas into the furnace;
b. introducing a non-reactive fluidizing gas through the nozzles so that the gas defines an upward flow in the furnace;
c. introducing untreated carbon black material into the furnace at a predetermined rate so the carbon black forms a fluidized bed;
d. energizing an electrode in the furnace to heat the fluidized bed to a temperature between 800 to 3000° C.; and
e. continuously collecting the treated carbon black from a furnace discharge pipe in the form of a graphitized carbon black having substantially no sulfur content, substantially no residual PAH content, minimal moisture pick-up and increased oxidation resistance.

18. A thermally modified carbon black for semi-conductive wire and cable applications, when prepared by a continuous electrothermal furnace treatment process, which exhibits a graphitized particle size of 7-500 nm and an oil absorption number of around 30-300 ml/100 gm; and the compound prepared from which exhibits superior interfacial smoothness with increased conductivity, and melt flow properties.

19. A thermally modified carbon black for zinc-carbon dry cell applications, when prepared by a continuous electrothermal furnace treatment process, which exhibits a graphitized particle size of 7-500 nm and an oil absorption number of around 30-300 ml/100 gm; and which exhibits a stronger structure and a greater resistance to oxidation than acetylene black.

20. A thermally modified carbon black for food contact-type applications, prepared by a continuous electrothermal furnace treatment process, which exhibits a graphitized particle size of 7-500 nm and an oil absorption number of around 30-300 ml/100 gm; and meets FDA requirements.

21. A thermally modified carbon black for moisture cured polymer applications, prepared by a continuous electrothermal furnace treatment process, which exhibits a graphitized particle size of 7-500 nm and an oil absorption number of around 30-300 ml/100 gm and reduced moisture pickup.

22. Thermally modified carbon blacks for semi-conductive wire and cable applications, which exhibit a graphitized particle size of 7-500 nm and an oil absorption number of around 30-300 ml/100 gm; and which provide, when compounded, superior interfacial smoothness with increased conductivity, and melt flow properties produced by the following heat treatment process:
a. providing an electro thermal furnace, a portion of the furnace defining a fluidizing zone, and a second portion defining an overbed zone; a plurality of nozzles for introducing fluidizing gas into the furnace;
b. introducing a non-reactive fluidizing gas through the nozzles so that the gas defines an upward flow in the furnace;
c. introducing untreated carbon black material into the furnace at a predetermined rate so the carbon black forms a fluidized bed;
d. energizing an electrode in the furnace to heat the fluidized bed to a temperature between 800 to 3000° C.; and
e. continuously collecting the treated carbon black from a furnace discharge pipe in the form of a graphitized carbon black having no sulfur content, minimal moisture pick-up and increased oxidation resistance.

23. Thermally modified carbon blacks for zinc-carbon dry cell applications, which exhibit a graphitized particle size of 7-500 nm and an oil absorption number of around 30-300 ml/100 gm; and having increased conductivity, produced by the following heat treatment process:
a. providing an electro thermal furnace, a portion of the furnace defining a fluidizing zone, and a second portion defines an overbed zone; a plurality of nozzles for introducing fluidizing gas into the furnace;
b. introducing a non-reactive fluidizing gas through the nozzles so that the gas defines an upward flow in the furnace;
c. introducing untreated carbon black material into the furnace at a predetermined rate so the carbon black forms a fluidized bed;
d. energizing an electrode in the furnace to heat the fluidized bed to a temperature between 800 to 3000° C.; and
e. continuously collecting the treated carbon black from a furnace discharge pipe in the form of a graphitized carbon black having no sulfur content, minimal moisture pick-up and increased oxidation resistance.

24. Thermally modified carbon blacks for moisture cured polymer applications, selected from a group including polyurethane foam applications; polyurethane acrylates, cyanoacrylates, epoxies and silicones applications, which exhibit a graphitized particle size of 7-500 nm and an oil absorption number of around 30-300 ml/100 gm; and having reduced moisture pickup properties produced by the following heat treatment process:
a. providing an electro thermal furnace, a portion of the furnace defining a fluidizing zone, and a second portion defines an overbed zone; a plurality of nozzles for introducing fluidizing gas into the furnace;
b. introducing a non-reactive fluidizing gas through the nozzles so that the gas defines an upward flow in the furnace;
c. introducing untreated carbon black material into the furnace at a predetermined rate so the carbon black forms a fluidized bed;
d. energizing an electrode in the furnace to heat the fluidized bed to a temperature between 800 to 3000° C.; and
e. continuously collecting the treated carbon black from a furnace discharge pipe in the form of a graphitized carbon black having no sulfur content, minimal moisture pick-up and increased oxidation resistance.

25. Thermally modified carbon blacks for food-contact type applications, which exhibit a graphitized particle size of 7-100 nm and an oil absorption number of around 30-300 ml/100 gm; and having reduced PAH content produced by the following heat treatment process:
a. providing an electro thermal furnace, a portion of the furnace defining a fluidizing zone, and a second portion defines an overbed zone; a plurality of nozzles for introducing fluidizing gas into the furnace;
b. introducing a non-reactive fluidizing gas through the nozzles so that the gas defines an upward flow in the furnace;
c. introducing untreated carbon black material into the furnace at a predetermined rate so the carbon black forms a fluidized bed;
d. energizing an electrode in the furnace to heat the fluidized bed to a temperature between 800 to 3000° C.; and
e. continuously collecting the treated carbon black from a furnace discharge pipe in the form of a graphitized carbon black having no sulfur content, minimal moisture pick-up and increased oxidation resistance.

26. An alkaline cell of an electrochemical system Zn/KOH/MnO2, comprising a thermally modified carbon black added to the cathode formulation.

27. The alkaline cell in claim 26, further comprising a thermally modified carbon black as the conductive additive used in combination with any other carbonaceous materials in the amounts of 0.01 to 8 wt % of the total amount of carbonaceous materials.

28. An electrochemical cell, comprising a thermally modified carbon black added to the electrode formulation.

29. The electrochemical cell in claim 28, further comprising a thermally modified carbon black as the conductive additive used in combination with any other carbonaceous materials in the amounts of 0.01 to 8 wt % of the total amount of carbonaceous materials.

30. The electrochemical cell in claim 28, wherein the cell would comprise a conductive coating of carbonaceous material in the amount of 0.01% to 99.9% of the total amount of carbonaceous material.

31. An assembly or a part of an electrochemical cell which comprises a thermally modified carbon black.

32. An assembly or a part of an electrochemical cell which comprises a thermally modified carbon black in the amounts of 0.01 to 99.9 wt % of the assembly.

33. The assembly in claims 31, wherein the assembly is prepared by a process selected from the group of pressing, molding, compacting, electro-consolidating, hot pressing or rolling.

34. An electrochemical cell comprising a thermally modified carbon black additive for the purpose of applications as a catalyst of chemical and electrochemical reactions and processes.

35. An electrochemical cell comprising a thermally modified carbon black additive for the purpose of applications as a catalyst of chemical and electrochemical reactions and processes used in amounts from 0.01 to 99.9% of the catalyst containing electrode.

36. An electrical resistance dependent application comprising a thermally modified carbon black as part of the formulation with other powdered materials in amounts from 0.01 to 99.9 wt % of the electrical resistance dependent application device.
